(19) United States
(12) Patent Application Publication
(10) Pub. No.: US 2026/0304164 A1
(43) Pub. Date: Oct. 1, 2026

(54) METHOD AND APPARATUS FOR DATA COLLECTION UNDER DYNAMIC NETWORK CONDITIONS

(71) Applicant: INTERDIGITAL PATENT HOLDINGS, INC., Wilmington, DE (US)

(72) Inventors: Taimoor Abbas, Sainte-Julie (CA); Michel Roy, Candiac (CA); Michael Starsinic, Newtown, PA (US); Samir Ferdi, Kirkland (CA); Ulises Olvera-Hernandez, Saint-Lazare (CA); Anuj Sethi, Ottawa (CA); Saad Ahmad, Montreal (CA)

(73) Assignee: INTERDIGITAL PATENT HOLDINGS, INC., Wilmington, DE (US)

(21) Appl. No.: 19/092,819

(22) Filed: Mar. 27, 2025

(51) Int. Cl. H04W 24/04; H04W 8/14

(52) U.S. Cl. CPC H04W 24/04; H04W 8/14

(57) ABSTRACT

A method for managing data collection (DC) sessions in a wireless network by a data collection function (DCF) is disclosed. The DCF monitors DC sessions using an abnormality detection mechanism and identifies issues based on notifications from application functions, wireless transmit/receive units (WTRUs), or network functions. Detected abnormalities may relate to unmet application requirements, QoS/QoE violations, or predicted congestion. Based on predefined rules, the DCF determines and initiates corrective actions, such as modifying, pausing, or terminating a DC session. A configuration request is sent to the WTRUs, which respond with an outcome. The DCF then reports this outcome to the application function. Notifications may include metadata such as impacted locations, affected base stations, or QoS parameters. The method supports use cases including AI/ML model training and enables dynamic adaptation of reporting frequency, buffering, and retry behavior in response to network conditions.

### BACKGROUND

Background Data Transfer (BDT) is a feature designed to efficiently handle large-volume data transfers while optimizing network resources. A BDT Session may be initiated by the network or the device. The BDT Policy may define when and how the data should be transferred. However, existing BDT present limitations for the data collection for AIML model training where the data is required to be transported in real-time. The existing mechanism may be fully controlled by the network and may not consider the application requirements (e.g., AF or UE). The existing mechanism may schedule the data transfer but does not allow real-time data transfer with adoption to dynamic network conditions, which may delay the training, e.g., data collection for real-time sensing applications under network congestion. It is unclear whether the current access control mechanisms for data collection are good enough. Therefore, there is a need to evaluate and enhance the wireless systems to enable efficient data collection for a group of devices in real-time for AIML model training.

### SUMMARY

To The present disclosure relates to methods for managing data collection (DC) sessions in a wireless communication network, particularly through a network node configured as a data collection function (DCF). The disclosed method enables intelligent monitoring and control of ongoing DC sessions by detecting abnormalities that may impact data quality, reliability, or network performance. The DCF monitors one or more DC sessions using an abnormality detection mechanism aligned with a data collection policy. When an abnormality is detected—based on, for example, notifications from an application function (AF), wireless transmit/receive units (WTRUs), or other network functions (NFs)—the DCF determines an appropriate corrective action based on predefined DC management rules. Abnormalities may include failures to meet data consuming application requirements, Quality of Service (QoS), Quality of Experience (QoE), or violations of a data reporting schedule. Corrective actions may include modifying, pausing, terminating, or updating the DC session, and are communicated to the WTRUs via a configuration request message. The WTRUs respond with an outcome of the requested action, which the DCF then reports to the AF. Notifications may include contextual metadata such as impacted geographic areas, affected base stations, and QoS parameters. The system also supports advanced use cases, including data collection for artificial intelligence or machine learning (AIML) model training, and can dynamically adjust reporting frequency, buffering behavior, and retry mechanisms in response to network conditions, such as congestion forecasts received from a Network Data Analytics Function (NWDAF).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 1E illustrates an example use case and topology for data collection;

FIG. 2 shows an example data collection use case for dynamic data collection control;

FIG. 3 shows an example use case of ongoing data collection and reporting;

FIG. 4 illustrates an example method performed by a network node functioning as a DCF for managing a data collection session; and

FIG. 5 illustrates an example method performed by a WTRU for participating in a data collection session.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

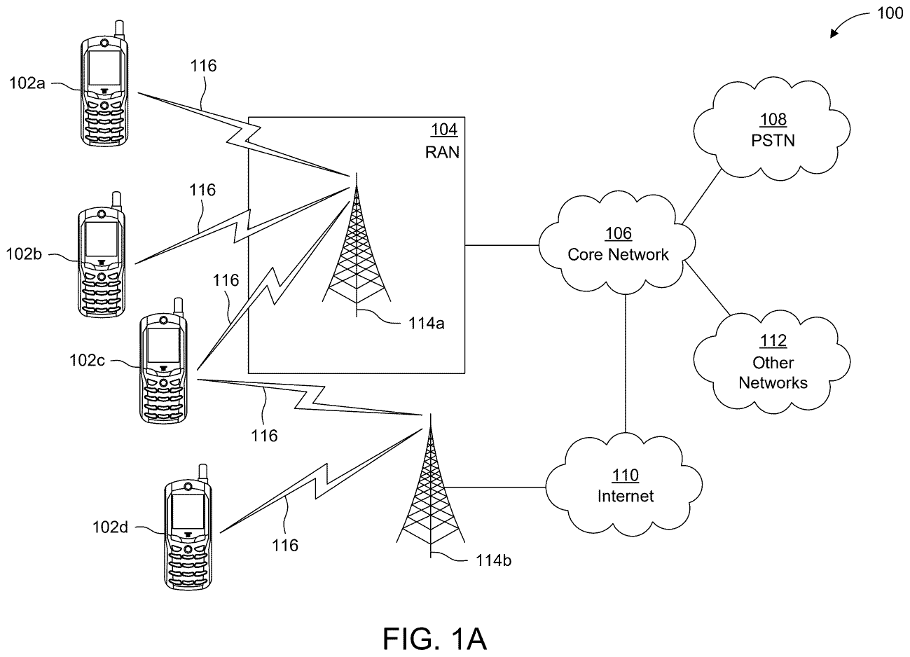

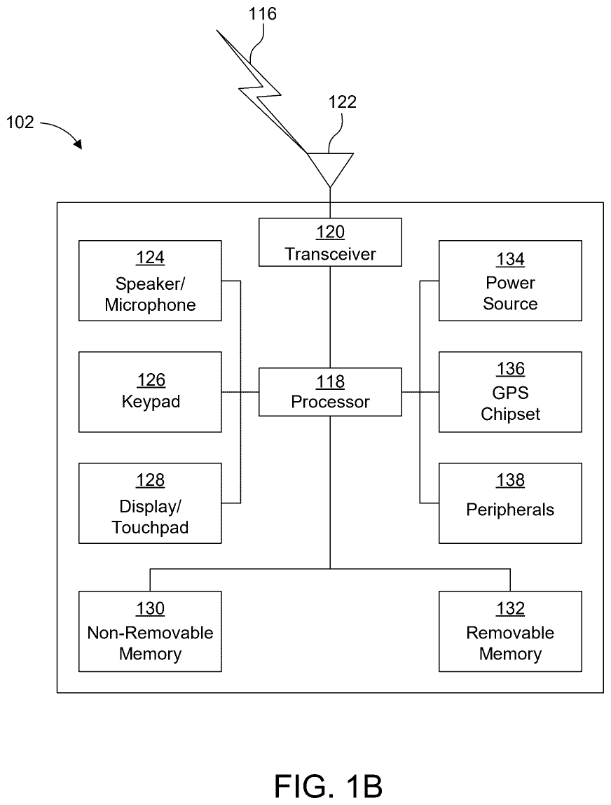

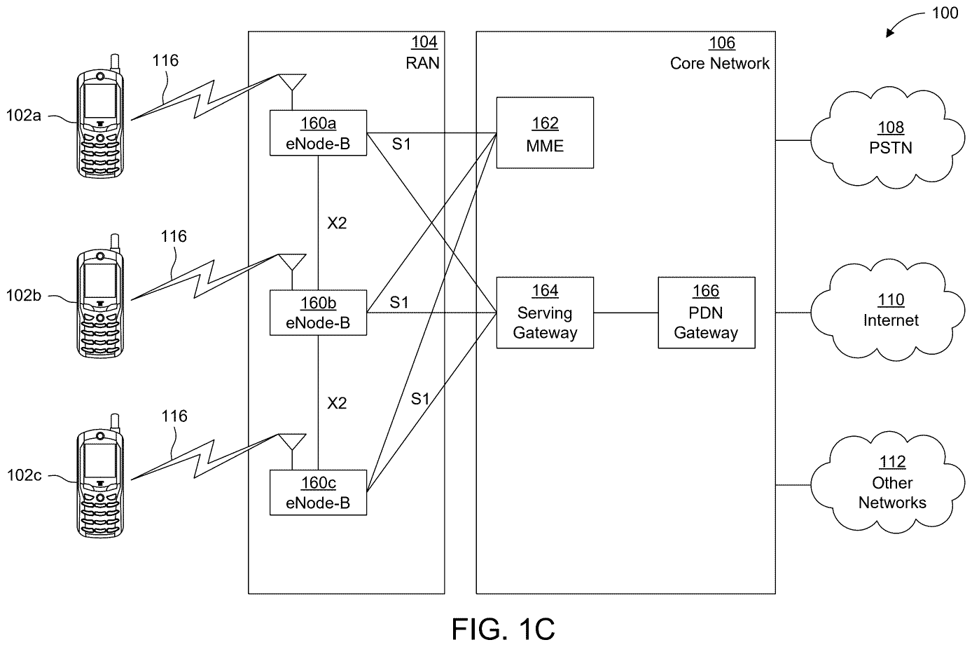

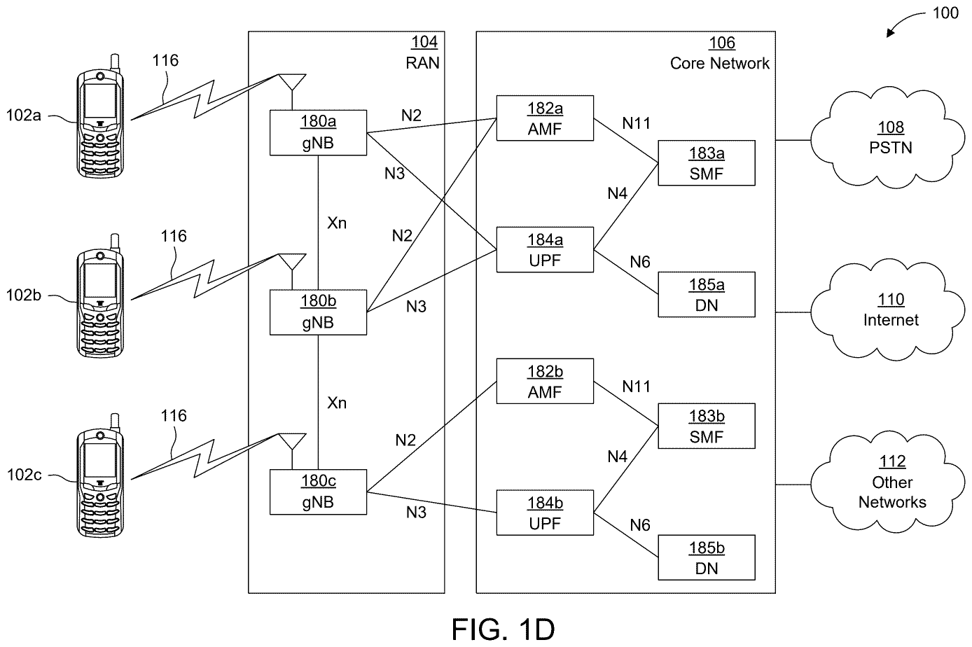

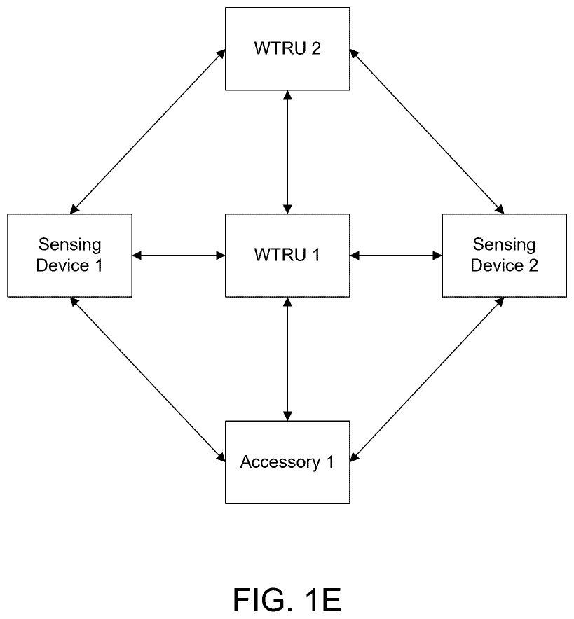

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1E illustrates an example use case for data collection involving sensing devices operating in a networked environment. At the center of the diagram is WTRU 1, which may communicate with multiple surrounding devices including Sensing Device 1, Sensing Device 2, Accessory 1, and WTRU 2. The arrows indicate that these devices can exchange data directly with WTRU 1. This setup reflects scenarios where a primary WTRU interacts with both 3GPP (e.g., via Uu interface) and non-3GPP (e.g., via Wi-Fi, Bluetooth, or USB-C) devices to facilitate centralized or distributed data collection.

The example topology of FIG. 1E may apply to applications like XR, AIOT, sensing, automotive systems, or various other devices operating in tandem and that may rely on a combination of direct and indirect communication paths. For example, if a device is not 3GPP-capable, it may still be part of the data ecosystem by connecting through another WTRU or via PC5 interfaces.

The role of NAS protocol in mobile networks is discussed herein. The NAS protocol refers to a layer of communication protocols used between a WTRU and an AMF located in the CN. The NAS protocol operates above the Access Stratum (AS) and plays a key role in managing signaling for mobility and session management. Many different mobile network functions are based on the NAS protocol; examples of mobile network functions based on the NAS protocol are described hereafter.

A first function based on the NAS protocol is Mobility Management (MM). The NAS protocol enables to manage location updates as the WTRU moves between tracking areas (TAs) and includes procedures like initial registration, deregistration, and connection management.

A second function based on the NAS protocol is Session Management (SM). The NAS protocol enables to establish, modify, and releases Protocol Data Unit (PDU) sessions for data transmission and support Quality of Service (QoS) management for applications.

A third function based on the NAS protocol is security management. The NAS protocol enables to provide mutual authentication between the UE and the Core Network (CN) network and facilitate encryption and integrity protection for NAS messages.

A fourth function based on the NAS protocol is paging coordination. The NAS protocol enables re-establishing communications with the WTRU when in idle mode.

A fifth function based on the NAS protocol is support for 5G system features. The NAS protocol enables slicing support, allowing the WTRU to connect to specific network slices based on service requirements, and enables managing dual connectivity and mobility across heterogeneous networks.

It can be appreciated that in 5G systems, the NAS protocol does not offer support for data collection and data collection session triggering or management.

The NAS protocol ensures efficient and secure communication between the WTRU and the 5GC by supporting features and functions expected in 5G networks. Examples of supported functions include secure and encrypted communications, mobility support, session management, scalability (e.g., large number of devices), QoS differentiation, etc.

The role of data collection in machine learning use cases is discussed herein. Data Collection (DC) is foundational to the success of Artificial Intelligence (AI) and Machine Learning (ML) systems as it can impact both training and inference stages.

The role of data collection for training ML models and using ML models for inference is described hereafter.

The ML model training involves creating an accurate model based on a provided dataset. An accurate model is a model that that has been trained to infer predictions and is performing to a certain level of accuracy (e.g., predictions are accurate).

The role of data collection in ML model training may be associated with different stages that are part of a training process. For example, a ML model training stage may build a relevant training dataset based on collected data (e.g., data quality, quantity, relevance). For example, a ML model training stage may require extracting features, or in other words processing collected raw data into features that can be used by the trained ML model. For example, a ML model training stage may require collected data labeling, or in other words annotating collected data with labels that can be used by the ML model to learn patterns. For example, a ML model training stage may require collected data bias reduction, or in other words, varied collected data to reduce prediction bias.

The ML model usage for inference involves making predictions or decisions based on new data (e.g., data different than the training data).

The role of data collection in ML model inference may be associated with various use cases. For example, a ML model inference use case may require data collection for providing real-time input data; the quality and accuracy of real-time collected data may impact the model's prediction accuracy.

Further, the role of data collection in ML model inference may be related to collecting inference data use cases. For example, a ML model inference results data collection may be necessary for continuous learning use cases where inference results are collected to be fed back into a ML model for retraining purposes. For example, a ML model inference results data collection may apply to contextual understanding use cases where a ML model may rely on collected contextual data (e.g., user behavior, environment) to provide accurate predictions.

The collected data may originate from different sources, may be provided at a different collection rate for each source, and maybe communicated in an uncoordinated manner. For example, WTRUs and/or base stations in a mobile system may provide such data.

The role of data collection in sensing use cases is discussed herein. DC is as foundational to the success of systems using sensing as it is essential for providing the sensing data in a consistent and timely manner.

Use cases requiring sensing information to be collected are numerous and varied; example use cases based on sensing data are provided hereafter.

Use cases based on sensed data may include smart transportation and mobility use cases (e.g., traffic monitoring/management, vehicle to everything (V2X) data collection.), environmental and infrastructure monitoring use cases (e.g., air pollution, seismic activity, smart grid monitoring, etc.), public safety and disaster response use case (e.g., emergency alerting, crowd density estimation, etc.), healthcare use cases (e.g., remote patient monitoring, infectious disease tracking, etc.), smart cities use cases (e.g., intelligent street lighting, waste management, noise pollution monitoring, etc.), industrial/agricultural use cases (e.g., precision agriculture, supply chain/logistics tracking, predictive maintenance, etc.), and in Augmented Reality (AR) and location based use cases (e.g., enhanced navigation, retail/marketing, gaming, etc.).

Applications using real-time sensing may require present sensing data, past sensing data and/or sensing data from various sources (e.g., fused sensing) to accurately re-create a virtual representation of reality based on a sensing dataset. Maintaining an accurate representation that closely tracks changes as they happen in real-time requires an efficient and reliable data collection framework.

In sensing use cases, the collected data may originate from different sources, may be provided at a different collection rate for each source, may have different payload size (e.g., dependent on the source), and maybe communicated in an uncoordinated manner. For example, WTRUs and IoT devices with sensing capabilities in a mobile system may provide such data.

Background data transfer mechanisms in 5GS are discussed herein. Background Data Transfer (BDT) is a feature designed to efficiently handle large-volume data transfers while optimizing network resources. It is particularly useful for IoT and MTC use cases where devices need to send or receive substantial data loads but can tolerate delays.

BDT operates by scheduling and managing bulk data transfers based on network policies, user profiles, and resource availability.

Key components of the BDT mechanism are described hereafter.

A first stage may be BDT session establishment. A BDT policy is pre-configured in the Unified Data Management (UDM) and communicated to the Policy Control Function (PCF). The BDT session may be initiated by the network (Network-Initiated BDT) or the device (UE-Initiated BDT). The BDT policy defines when and how data should be transferred, including allowed time windows for transfer, preferred access types (e.g., 4G, 5G, Wi-Fi), and data volume thresholds.

A second stage may be network-assisted BDT scheduling. The PCF ensures BDT traffic is scheduled during low-congestion periods to optimize network efficiency. The Session Management Function (SMF) and User Plane Function (UPF) handle the data forwarding according to the policy. BDT can use Non-Guaranteed Bit Rate (non-GBR) Quality of Service (QoS) levels to avoid impacting real-time services.

A third stage may be bulk data transfer execution. The device (WTRU) waits for the BDT trigger from the network or follows predefined transfer conditions. Data is sent or received over a dedicated PDU session. The AMF and SMF coordinate with the WTRU to manage mobility and session continuity.

A fourth stage may be BDT completion and reporting. Once the BDT session is completed, a BDT report may be sent to the network for analytics and optimization. The system may use a Network Data Analytics Function (NWDAF) to refine future BDT scheduling.

In some cases, BDT may provide efficient network utilization by deferring non-urgent bulk transfers, thereby reducing peak-time congestion. In some cases, BDT may also provide energy savings by optimizing devices power consumption by avoiding unnecessary wakeups. In some cases, BDT may provide flexible policies by allowing operators to configure BDT to meet business needs, such as offloading traffic to Wi-Fi or prioritizing enterprise applications.

Background Data Transfer Quota (BDTQ) is an extension of the BDT mechanism to further optimize network resource utilization and provide more granular control over bulk data transfers. BDTQ extends BDT by introducing quota enforcement, ensuring that bulk data transfers remain within predefined limits, improving network efficiency, and enhancing user experience.

A BDTQ quota-based mechanism may regulate the volume of bulk data that a device or group of devices can transfer within a specific time frame. This allows for network load to be managed more effectively, especially for IoT and Machine-Type Communication (MTC) applications.

A BDTQ policy may define a total volume of bulk data a device (WTRU) or group of WTRUs can transfer within a given time window. The PCF assigns and enforces the quota based on operator-defined rules. The SMF monitors data usage and reports quota consumption. If the quota is exhausted, further bulk data transfers may be delayed, throttled, or blocked until a new quota period begins. BDTQ quotas can be assigned per WTRU, group of WTRUs, slice, or application type and can be defined for specific access networks (e.g., 5G, 4G, Wi-Fi).

BDTQ scheduling may allow the network to prioritize bulk data transfers based on time-of-day policies, network congestion, and user profiles. The NWDAF may be used to optimize future quota allocations based on usage patterns. Once a BDTQ period expires, the quota resets based on predefined policies. The network may notify the user, or user equipment, when approaching or exceeding the quota.

Mobile networks may use AIML models to predict network behaviors both in real time and over a longer period. ML models can be applied to applications such as AR/VR, AIOT, Sensing, Automotive etc. for their efficiency and robustness. These ML models require a reliable and efficient distributed data collection framework that allows collection of data from different sources, e.g., the devices supporting at least one application (like XR, sensing etc.) with the capability to collect and report data to the mobile network. The coordinated data collection from these distributed sources presents several challenges, especially when the number of sources is large and/or distributed, which are described hereafter.

A first challenge is related to bulk data collection from a very large number of WTRUs. In some examples the application function (AF), e.g., based on internal trigger or request from an OTT server, may require data to be collected in real-time from thousands of devices for a specific application in a certain location. In another example, an AF may require data to be collected from 1000s of devices but for several different applications in a certain location. There are several other examples of bulk data collection for AIML models. For any of these scenarios where 1000s of devices are involved in data collection and reporting, system enhancements are needed to efficiently collect the data in real-time.

A second challenge is related to the network load management and congestion. In some examples, the network may experience congestion due to high user density, limited spectrum availability, traffic load, backhaul bottleneck etc. Under such conditions network KPIs are impacted, e.g., increased latency, higher packet loss, and reduced quality of service (QoS). If the application server requires bulk data transfer from 1000s of devices, the network may be under congestion, and some or all the devices may be impacted due to congestion. Thus, solutions are need to coordinate the data collection from the devices for better load management. Solutions need to utilize network resources efficiently, without compromising the data collection and reporting requirements for the AIML models.

Enhancements to the DC framework are vital to enable bulk data collection in real-time for many devices. The solutions should also minimize the impact on the network performance degradation. For AIML model training (e.g., federated learning use cases) or re-training, there could be a requirement to collect bulk data from 1000s of devices. The proposed data collection framework supports an efficient and reliable data collection mechanism without compromising the mobile network efficiency.

In an embodiment, a procedure is introduced that defines how the data collection policy is provided to the WTRUs to collect data for model training, based on the existing procedures. Once the data collection is ongoing, there might be a situation, e.g., congestion, detected by the WTRU, by the DCF (Data Collection Function), or by the AF, which triggers the DCF to re-evaluate the policy and determine appropriate action for the WTRU regarding data collection under the given network condition. The DCF sends a message to the WTRU to indicate whether to buffer, discard, or stop data collection.

In another embodiment, a procedure is introduced to define how to warn the DCF if the WTRU, network or AF experiences a condition (such as congestion, insufficient data, etc.) while the data collection is ongoing. A procedure to address on how the DCF may receive updated data collection rules from the AF, which are used to determine the appropriate action by the DCF for the WTRU under network condition, is also provided herein.

The data collection at the WTRU is performed to construct a data set which may be used to train AIML models or may be collected to update the relevant data set for the AIML model retraining or may be collected to provide sensing data consumers (e.g., consumer AF/NF) with sensing data.

In some examples the AF or mobile networks may require data to be collected from a few or a large number of WTRUs. In the current systems the background data transfer (BDT) mechanism is used to scheduled large data transfer, where BDT session may be initiated by the network (Network-Initiated BDT) or the device (WTRU-Initiated BDT). For the BDT based data collection procedures, the WTRU is configured by the PCF with the data collection configuration.

In another example the WTUR may receive a data collection configuration over the application layer via the data collection function (DCF). However, the existing data collection framework does not fully support data collection requirements for the situations where the network undergoes a condition such as congestion. Exiting data collection framework does not address the situation where the AS may detect that the collected data is insufficient to train the models, inconsistent, or maybe incomplete.

A solution is proposed herein on how the DCF may manage the WTRU data collection under these circumstances, i.e., when a warning is issued for the DCF the DCF may send a message to instruct the WTRU with an appropriate action based on the reported condition and the data collection requirements.

The proposed solution builds on top of existing mechanisms, which can be used in conjunction with existing data collection framework to manage the network load and to optimize the use of resources, as a preventive measure to avoid network performance degradation, or as a reactive approach where the network responds to changing network conditions. This is achieved through asking one or multiple WTRUs to buffer the data, discard the data or stop the data collection and reporting for a duration when the network undergoes congestion or performance degradation.

The following solutions assume the use-cases where data collection is required for AIML model training, and can be time-sensitive, or scheduled data. The mobile network can be under normal condition or under an extreme load condition. The data may be coming from many WTRUs which are in several different locations.

The following solutions assume the devices (WTRUs for which data needs to be collected) may be operating in a distributed manner. These devices may be located across a geographical area such that they are served by one or more gNodeB(s). These devices may be running several applications and data may be collected for one or more applications. The devices could be required to collect the data in real-time, and the time-window could be very small for the data collection.

The following solutions further assume the WTRU (each device) may have one or more applications (active) for which the data is requested to be collected and reported to the application function (AF). The AF for the control signaling may interact with the applications on the WTRU, via the data collection function (DCF) on the network side, via the data collection client (DCC), and/or via the data collection adaptation layer (DCAL) on the WTRU side. DCAL is adaptation layer, which serves one or more DCC on the WTRU. The collected data is transferred over the data plane from the WTRU to the network.

A Data Collection Function (DCF), Data Collection Server Function (DCSF), Data Collection Application Function (DCAF) or Data Collection Server (DCS) may be responsible for the management of a Data Collection Configuration Profile and/or Policy (DCCP or DCP). Herein after DCF will be used for simplicity, and may refer to any of DCSF, DCAF, DCS or similar network entities. Such network entity, e.g., DCF, may be in the 3GPP 5G and/or next generation core network as an independent core network function or it may collocate with another core network function. A DCF may also be in the application layer domain as a data collection server function located with the application function. The DCP may be used to configure the WTRU and the network nodes with regards to collected data content and its handling before its transfer to an AI/ML training entity (e.g., OTT server, NWDAF).

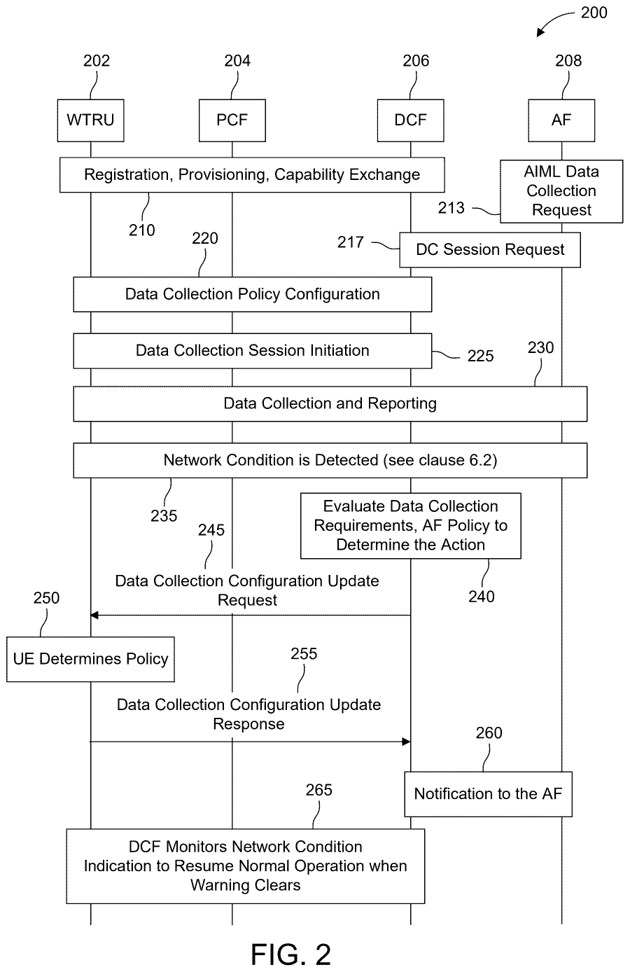

FIG. 2 shows an example data collection use case 200 for dynamic data collection control. The use case of FIG. 2 assumes that WTRUs have registered and provided their data collection capabilities with the network at 210, an application function (AF) 208 gets triggered at 213 to start data collection (e.g., either via a received request or internally), for example for AIML model training. The AF 208 may trigger DC session, at 217, by sending a DC session request to a network function (e.g., the DCF 206). The DCF 206 may initiate a DC session by requesting a DC policy configuration procedure, at 220, with the PCF 204, to configure the WTRU 202 with a data collection policy. The DCF 206 may initiate a data collection session at the WTRU 202, at 225. Data is collected at the WTRU then reported to the DCF 206 and AF 208, at 230.

It can be appreciated that once the session starts, the WTRU 202, the network or the AF 208 may encounter conditions that affect the requested data collection; for example, a WTRU may not be able to send the collected data, the network may experience congestion, or the AF 208 may be dissatisfied with the QoE of the requested data collection.

The solution of FIG. 2 provide means to report and to mitigate conditions detected at the WTRU, in the network or at the AF 208 and defines how to dynamically handle such conditions by enabling the DCF 206 to manage a data collection session. A more detailed description of each step of FIG. 2. is provided below.

At 210, the WTRU registers and indicates data collection capability with the network to indicate that the WTRU is capable for data collection. In this step each WTRU registers individually and each WTRU may be provisioned with individual data collection and reporting configuration(s). WTRU registration and capability exchange may be the NAS (Non-access stratum) registration with the network and/or registration with the DCF over the control and/or the user plane.

At 213, AF 208 determines to or is triggered for creating a data collection session. For example, the AF 208 may need to (re)train a ML model and the AF 208 may need data from one or more WTRU(s) (e.g., a group consisting possibly of a large number of UEs in an area). The determination may be based on an event at the data consumer. For example, the AF 208 may be an AF interacting with the core network via the NEF, an AIML enablement server triggered by receiving a VAL server request to perform ML model training, or a NF, such as NWDAF, that determines that a model performance is degraded and needs to retrain such model.

The AF 206 may determine AF data collection requirements based on a pre-configuration or based on information received from a request. The AF data collection requirements may include the number and/or identity and/or characteristics (e.g., location, subscription information, capabilities, etc.) of WTRUs from which data needs to be collected, the time window when data needs to be collected, the amount (e.g., size) of the data to be collected, type of data to collect, the time-sensitiveness of the data collection, etc.

The AF 206 may perform member WTRU selection (via NEF), i.e., selecting required WTRUs, based on UE characteristics for which the data needs to be collected or may be provided with a list of member WTRUs for data collection. The member selection may consider certain characteristics for a WTRU based on the requirements, e.g., WTRU fulfills the data collection requirements, WTRU meets data collection privacy, subscription, and/or user consent requirements etc.

At 217, the AF 208 initiates the DC session establishment by sending a DC session request to the DCF 206. The DC session request may include input parameters determined and described with respect to 213.

The DC session request may additionally include DC management rule information that indicates how the DCF 206 should manage the data collection session at the DCF 206. The DC management rule information may include, for example, thresholds on the minimum and/or maximum number of WTRUs for data collection; allowed data collection latency; minimum and/or maximum data volume; and minimum and/or maximum time duration for a data collection session. The DC management rule information may also specify the time period or interval for the session, as well as the validity duration of the rules. Additionally, the DC management rule information may include an indication of whether the DCF is permitted to select new WTRU members and initiate a DC session with them if the low WTRU threshold is crossed, or to terminate sessions if the high WTRU threshold is exceeded. The DC management rule information may further define characteristics for selecting member WTRUs, including preferred and additional WTRUs, as well as criteria for dynamically discovering and selecting additional WTRUs, if the DCF supports this capability. There may also be provisions for managing data volume when thresholds are crossed, such as adding or removing WTRUs or adjusting the reporting schedule or frequency of DC sessions. The DC management rule information might also indicate whether the DCF can perform traffic influence when latency thresholds are exceeded, including any applicable traffic influence limits. Finally, load balancing rules may be included in the DC management rule information to guide the DCF in distributing load between different DC sessions in order to meet performance requirements at the group level. The DC management rule information may indicate the expected QoE limits of the AF 208 with regards to the data collection parameters. The DC management rules may be used by the DCF for managing and/or controlling the data reporting at the group level for ongoing data collection sessions involving one or more WTRUs.

In one example, the DC management rules may indicate a list of preferred WTRUs for the DC session, e.g., based on the preferred location(s) or application(s), which are important for model (re)training. The AF 208 provides a list of WTRU IDs and DC session ID to the DCF 206.

The DCF 206 may communicate with the AF to obtain new or updated DC management rules, for example if DC management rules have expired, then the DCF 206 may send a request to the AF 208 to request new or updated DC management rules, and may receive a response including new or updated DC management rules. Alternatively, the DC management rules maybe pre-configured on the DCF which are used as default when no DC management rules are provided in the DC session request.

The DC session request may additionally include WTRU's DC behavioral information related to the DC session. WTRU behavioral DC information may indicate the frequency at which data collection is expected, a reporting schedule, buffering size/time limits, an indication on whether to buffer or discard the collected data that cannot be sent, an indication whether to use an alternate (e.g., relaxed) transmission schedule. For example, if the DC management rule indicates a list of preferred UEs associated to a DC session, then for this action there may be an associated DC behavioral information that indicates to the DCF 206 to prioritize data collection only from the provided preferred WTRU list, e.g., if network experiences congestion and all UEs are unable to transport the data. The DC behavioral information may also indicate that the DCF 206 may request the remaining UEs, previously selected for the same DC session, to stop DC and reporting.

The DCF 206 may verify whether the data consumer, e.g. the AF 208 or OTT server, is authorized for the DC operation, send an indication of success in a DC session response to AF 208. In an alternative embodiment the DC session response maybe sent after the 220 or 225, i.e., after the DC policy is configured on the WTRU and it is acknowledged to the DCF 206 by the WTRU. In an example, the DCF 206 may successfully verify the AF 208 but due to network condition or unavailability of resources, the DCF 206 is unable to entertain the DC session request from the AF 208. In that case the DCF 206 may send a DC session reject message or DC session reject indication in DC session response message to the AF 208, with an appropriate cause, e.g., DCF 206 unavailable. In an example if the DCF 206 is unable to verify the data consumer then it may sends reject message as above or simply ignore the DC session request from the AF 208.

The DCF 206 may serve one or more consumers, and/or may have one or more active data collection sessions per consumer, e.g., the AF 208. The DC management rules may indicate how to prioritize the DC sessions, consumers, it may indicate how to perform load balancing and when to terminate the DC session for one or more consumers. The DC management rules may also indicate associated network conditions when these rules are applicable and may also be configured with cause values, which can be provided if the DC session termination notification is sent to the consumer by the DCF 206.

The DCF 206 (based on the input parameters in DC session request and operators' policy) may construct a DC profile (DCP). In an example one DCP may be associated with a ML model, or multiple ML models, whereas the ML model info is provided to the DCF 206 by the AF 208. In an example one DCP profile maybe to collect time-sensitive AIML data from a large number of WTRU(s). In an example one DCP can be associated with an area of interest and applicable to all the UEs that are located in that area. In an example one DCP profile maybe associated with a group of WTRUs server by one or more gNB. A DCP may be identified by a DC profile ID and/or a DC session ID.

At 220, the DCF 206, upon reception of DC session request and determination of a DC profile, may initiate a DC policy configuration with the PCF 204. The DCF 206 may send a request to the PCF 204 and include the information associated with the DC session.

The PCF 204 may determine a data collection policy based on AF data collection requirements which may include characteristics (e.g., location, subscription information, capabilities, etc.) of WTRUs from which data needs to be collected, the time window when data needs to be collected, the amount (e.g., size) of the data to be collected, type of data to collect, and/or the time-sensitiveness of the data collection.

The PCF 204 determined data collection policy may further be based on WTRU DC behavioral information related to the DC session which may include the frequency at which data collection is expected, a reporting schedule, buffering size/time limits, an indication on whether to buffer or discard the collected data that cannot be sent, and/or an indication whether to use an alternate (e.g., relaxed) transmission schedule.

The PCF determined data collection policy may further include an indication whether the trigger to initiate data collection at the WTRU 202 should be based on the reception of the data collection policy (e.g., which may include the data collection parameters) or on the initiation of the data collection session at 225.

The DC policy configuration request may include some or all the parameters, as received by DCF 206 at 217 from the AF 208. The PCF 204 may create a DC policy considering the provided DC session requirements and the PCF 204 policy may include rules indicating the expected DC behavior at the WTRU. The DC policy may have a policy identifier and may include a DC profile ID and/or DC session ID indicating for which session the DC policy applies.

The DC policy may additionally include a supported or preferred (over RRC connection, CP or UP) transport method for data collection and a transport method selection policy, i.e, small data transfer and no latency restrictions may select RRC, CP or UP, whereas large data size may select UP as data transfer method.

The PCF 204 may deliver the determined data collection policy to one or more WTRUs member of the data collection group based on the number and/or identity of WTRUs determined at 213 and received at the DCF 206 at 217.

The PCF 204 may configure each WTRU with the data collection policy and indicate in the policy that the policy ID is associated with a DC profile ID(s) and/or the DC session ID.

In one example embodiment, the DC configuration may also include a trigger indication indicating to the WTRU 202 that data collection may be initiated at the WTRU 202 on reception of the DC policy.

The PCF 204 may send a message to the DCF 206 to indicate the creation of the data collection policy associated with the DC profile and/or DC session identifier. The message may include an indication that a DC policy was created, a DC policy identifier, an indication that the DC policy was delivered to the member WTRUs.

In one example embodiment, once the DC configuration is completed, the DCF 206 may send a DC configuration response to the WTRU which includes the acknowledgement of the DC policy configuration.

At 225, the DCF 206 may initiate the data collection session at the WTRU 202 based on input parameters received at 217 and the indication that a DC policy was created at 220. The DCF 206 may initiate the data collection session with each member WTRU (e.g., with the data collection client present on each WTRU) over the application layer.

The data collection session initiation may include a DC profile, a DC session identifier and a DC policy identifier.

In one example if DC policy is configured on the WTRU 202 using the procedures at 220, then step 225 may only be used as a trigger to initiate a data collection session creation and data collection reporting by the WTRU.

At 230, the WTRU 202 starts collecting and reporting data based on the DC policy and data collection session parameters. The data collection session is created and the data collection is performed by the WTRU 202 according to the configured DC policy and sent to the DCF 206 and/or AF 208 based on the DC policy which is associated with the relevant DC profile ID, and DC session ID.

At 235, upon initiating the data collection session, the WTRU 202 and/or DCF 206 and/or AF 208 may initiate detection mechanisms to monitor the data collection session progress. The detection mechanism may monitor whether the data collection is happening as specified in the policy and may detect anomalies associated with the data collection session.

The WTRU 202 may monitor that data collected is sent to the network according to the transmission schedule established in the policy and may detect when the transmission schedule cannot be met. It can be appreciated that the DC policy or DC rules may indicate WTRU behavior when data cannot be reported based on the reporting schedule. For example the policy may indicate that the data should be buffered, may indicate a maximum buffering level or time, and may indicate that collected data should be discarded. Upon detecting a DC session progress anomaly and/or taking any action based on the DC policy, the WTRU 202 may report to the DCF 206 which action was taken (e.g., buffering, buffering level, discarding, etc.) and for how long. This information may allow the DCF 206 to evaluate corrective actions as described herein.

The DCF 206 may monitor to ensure that all member WTRUs part of the data collection session are providing the requested data according to their reporting schedule and may determine WTRU identifies that are not providing collected data, or that do not meet the data collection transmission schedule. This information may allow the DCF 206 to evaluate corrective actions as described herein.

The AF 208 may monitor the QoE for the data collected and may determine if the received data meets the requirement of the AF, for example for training a ML model. When the AF 208 detects that the AF QoE requirements are not being met based on a DC session progress requirement, the AF 206 may identify which DC session parameters are not met. The AF 208 can then report both the anomaly and/or the unmet parameters to the DCF, along with the duration of the issue. This information may help the DCF 206 evaluate and take appropriate corrective actions as described herein.

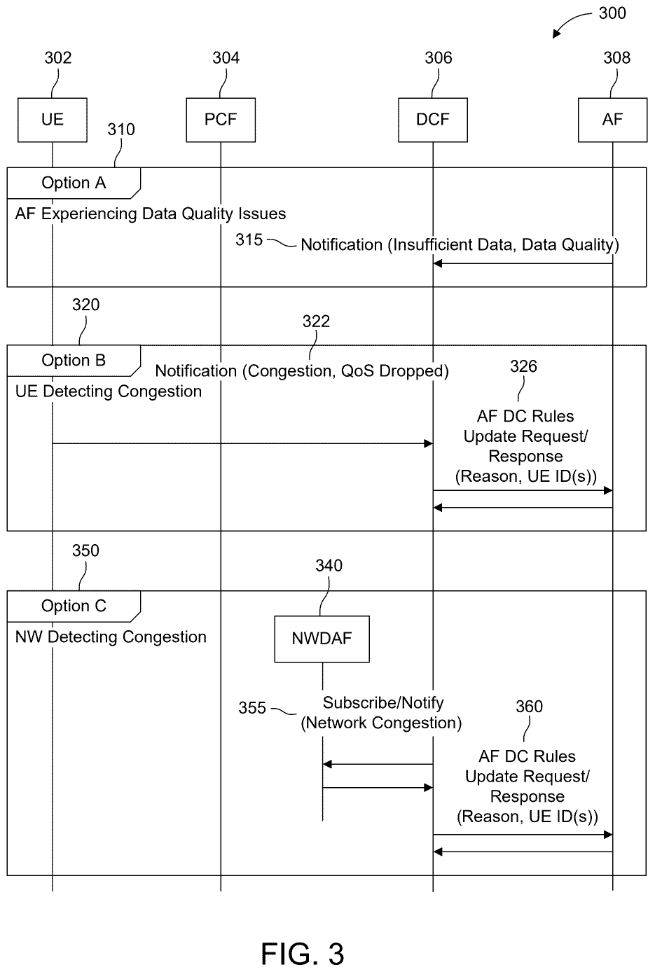

Additional examples of WTRU conditions are provided herein. For example, a WTRU may be powered down, experiences low-power, may be unable to deliver data due to network congestion, or may go out of coverage. The details on how different entities such as WTRU 202, the DCF 206, and the AF 208 may experience issues and what might be the consequence is elaborated with respect to FIG. 3.

At 240, on detection of a DC session progress anomaly (e.g., detected at the DCF 206, or reported by the WTRU 202, AF 208 or network) the DCF 206 may determine possible corrective action may be taken for the detected anomaly. One of the conditions described below with respect to FIG. 3, may indicate abnormal DC session progress detection at the DCF 206. The condition indication may be detected at the DCF 206 or may be indicated by the WTRU 202, the network (e.g. NWDAF) or from the AF 208. The warning (as received at 235) may include a reason/cause code, DC profile ID, DC session ID, a DC policy ID, an impacted location, list of gNBs impacts, QoS not met (high latency, low data volume), WTRU identifiers, or any other parameter associated with the data collection policy.

Based on the received abnormal DC session progress detection, the DCF 206 may determine corrective action for the detected anomaly. For the determination of action, it may identify the impacted session, associated DC profile, and/or impacted list of WTRUs. The DCF 206 then may use that information together with the data collection requirements, i.e., requested list of WTRUs, requested location, size of data, duration of data collection, etc. in consideration with data collection rules, i.e., min/max thresholds for data accuracy, volume and latency, as received from the AF 208.

### The DCF 206 may determine corrective actions based on the DC management rule information.

In one example the DCF 206 may determine that some WTRUs have not been reporting the data regularly, i.e., data collection reports are missing at intervals or not reported according to a schedule. The DCF may use a threshold for the minimum number of WTRUs from the DC management rule information to determine if an action should be taken. For example, if the threshold on reporting WTRUs is not crossed, the DCF 206 may decide to take no corrective action. For example if the threshold is crossed, the DCF 206 may determine to discover and add more WTRUs to the member or notify the AF 208 to request new member WTRUs. Adding new member WTRUs may require updating the PCF (e.g., policy) such that the policy is delivered to the new members.

In one example, the DCF may determine that the WTRU 202 is unable to be reached or unavailable, which could be due to congestion or out-of-coverage. In one example, the WTRU 202 is reporting the data but the data is not accurate, e.g., incomplete and not all the requested parameters are reported. For such situations, the DCF 206 may revoke (e.g., terminate) or pause the WTRU participation in the DC session. The DCF 206 may ask the WTRUs to stop data collection if the WTRU 202 is experiencing low-power, or if the network is under congestion and the DCF 206 may down select only a subset of WTRUs. Hence all other WTRUs are asked to stop data collection to save on the network resource utilization.

At 245, The DCF 206 may send a message to the WTRU 202, e.g., data collection configuration update requests. The DCF 206 may send this message to WTRU data collection client over the application layer. The request may update the DC session configuration based on a determined corrective action from the DCF 206. For example the DCF 206 may have decided to relax the DC reporting schedule, the DCF 206 may have decided to stop data collection for a specific session and profile, and/or the DCF 206 may have schedule data collection differently in different location etc. The request message may also include the relevant DC profile ID and DC session ID, so the WTRU 202 knows for which profile and session the new instruction is indicated.

At 250, based on the indication from the DCF 206, the WTRU 202 may update DC session parameters. The indication may be to terminate, pause, modify or update data collection session parameters.

At 255, the WTRU 202 sends a response message to the DCF 206, e.g., data collection configuration update response to acknowledge the request is successful. It may also provide what action should be taken and for which DC session ID based on the DC configurations. In an example, the WTRU 202 at 250 determines that the WTRU 202 is unable to meet the requirements based on the updated DC configurations, e.g., WTRU 202 is low on power and/or in power saving mode, then the WTRU 202 may send rejection to the DCF 206 in a message, e.g., indication DC configuration update response message or DC configuration rejection message, and indicating cause of rejection, e.g., power saving enabled.

At 260 the DCF 206 may notify the AF 208 about a detected anomaly in the DC session progress and/or may indicate if a previously detected condition clears. For this the DCF 206 may use the notification message to notify the AF 208 about the updated network condition. This notification may allow the AF 208 to react to changes in the DC session and adjust accordingly.

At 265, the DCF 206 monitors network conditions to determine whether warning clears for example, the DCF 206 may subscribe to the NF, e.g. NWDAF, which notifies the DCF when the network condition, e.g., congestion, is over. In an example, the DCF 206 determines that the DC may resume after interruption, and the data being collected meets the DC session requirements. Once the warning clears, the DCF 206 provides an indication to the WTRU(s) to resume normal DC operation and also notifies the AF 208 that the warning clears. The DCF 206 may send this notification to WTRU 202 in a DC session initiation message, or to the WTRU 202 and AF 208 in a dedicated DC session resume notification message.

FIG. 3 shows an example use case 300 that assumes that the data collection and reporting is ongoing to collect AIML data from a group of WTRU(s). In FIG. 3, the WTRU 302, the network, e.g., NWDAF 340, or the AF 308 detects a condition, e.g., congestion, insufficient data etc.

Beginning with option A, 310, in one example the AF 308 may determine that the collected data received by the AF 308 does not meet AIML model(s) training requirements, i.e., data set is too small, insufficient parameters, inconsistent data implying that the data sample are missing for different occasions or intervals etc. Under these circumstances the data is collected by the WTRU 302, but it may not be well suited for AIML model training.

If such a situation is detected, the AF 308 may notify the DCF 306 about the situation by sending a notification message and including an indication or a cause code to indicate that the data is either not needed or a data collection session needs to be restarted, at 315. If a data collection session needs to be restarted then all the WTRUs participating in the DC session should be indicated to stop data collection. The indication sent to the WTRUs may also include impacted session ID, may include a list of WTRUs, may include the location and the time values for which AF has detected issues.

Next, at option B in an example, the WTRU 302 may detect congestion and cannot meet the QoS requirements (latency, accuracy) for data collection and transfer. In another example, a WTRU 302 may get selected for data collection for a certain AIML model, but the WTRU 302 may determine that it does not have the required configuration (E.g., measurement configuration) to collect the data. The WTRU 302 may learn this by comparing the required data types to be collected from the DCP and the data which is currently collected by the WTRU 302. In such a situation it may reject the data collection request. In another example the WTRU 302 may experience limited-power and may not want to participate in data collection.

Given that in these examples, the data collection is ongoing at the WTRU, and one of the above or similar situations occurs at the WTRU 302, the WTRU 302 (e.g., data collection client) may send a notification to the DCF 306 that includes a cause code that indicates the cause, at 322. For example, the cause code may indicate e.g., congestion with QoS drop, power-saving mode enable, incompatible WTRU with missing configuration etc.

At 326, the indication can be received by the DCF 306 from one or more WTRUs. Upon reception of such indication, the DCF 306 may send a request message to AF 308. The DC rule update request is to ask for updated data collection rules that may assist the DCF 306 to decide on how to handle such conditions. The request message may include additional parameters such as cause code/reason, location(s), session ID(s) and/or DC profile ID(s).

The AF 308 reads the input parameters and determines the new rules, e.g., do nothing (list of WTRUs, locations(s), session ID(s)), ask to buffer the data (Important data, list of WTRUs, locations(s), session ID(s), thresholds for latency), and discard or stop the data (list of WTRUs, locations(s), session ID(s)).

At option C, 350, in an example, the DCF 306 may subscribe to the NFs, e.g., NWDAF 340, and request the NF to indicate when the network may experience congestion due to high user density, limited spectrum availability, traffic load, backhaul bottleneck etc., at 355. Under such conditions network KPIs may be impacted, e.g., increased latency, higher packet loss, and reduced quality of service (QoS).

In another example, a use case is considered assuming there are 1000s WTRUs for which the data collection and reporting is ongoing. A portion of the WTRUs are in an area where there is no congestion. The remaining WTRUs may experience congestion as indicated by the NF at 355. In this case when the AF receives a congestion warning, which includes either the list of WTRUs or areas, then it may only request new data collection policy for the impacted group of WTRUs, e.g., new policy for the subset of WTRUs. This can be further expanded to various sub-sets of WTRUs out of all 1000s of WTRUs. Accordingly, it is proposed that there can be different policies for each group, or sub group, and the content of each policy can be different based on the network conditions.

At 360, the NF, e.g., NWDAF 340, may trigger a warning towards the DCF 306 (by sending a notification), which provides a warning with an indication on the specific details of the network condition, the location and/or the impact WTRUs or gNBs. Based on that the DCF 306 may identify the relevant DC session IDs. The DCF 306 may also send a request to AF 308, similar to step 2b above.

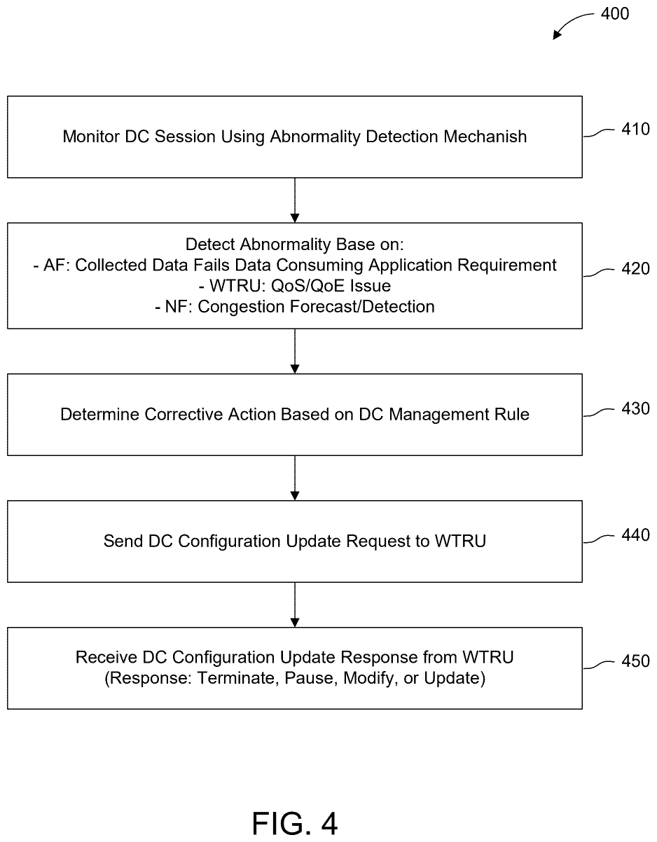

FIG. 4 illustrates a method 400 performed by a network node functioning as a DCF for managing a data collection (DC) session. The process begins at 410, where the DCF monitors the DC session using an abnormality detection mechanism to ensure that data collection proceeds according to a defined policy. At 420, the DCF detects an abnormality based on inputs such as a notification from an Application Function (AF) indicating data insufficiency, a report from a wireless transmit/receive unit (WTRU) signaling QoS or QoE issues, or a notification from a network function (NF) forecasting congestion. At 430, the DCF determines an appropriate corrective action based on predefined DC management rules and the nature of the detected abnormality. The DCF then sends a data collection configuration update request to the WTRU at 440, specifying the corrective action, which may include termination, pause, modification, or update of the session. Finally, at 450, the DCF receives a response from the WTRU indicating the outcome of the action taken, completing the anomaly resolution cycle. Optionally, the DCF may send a message to the AF indicating the corrective action outcome based on the data collection configuration response message.

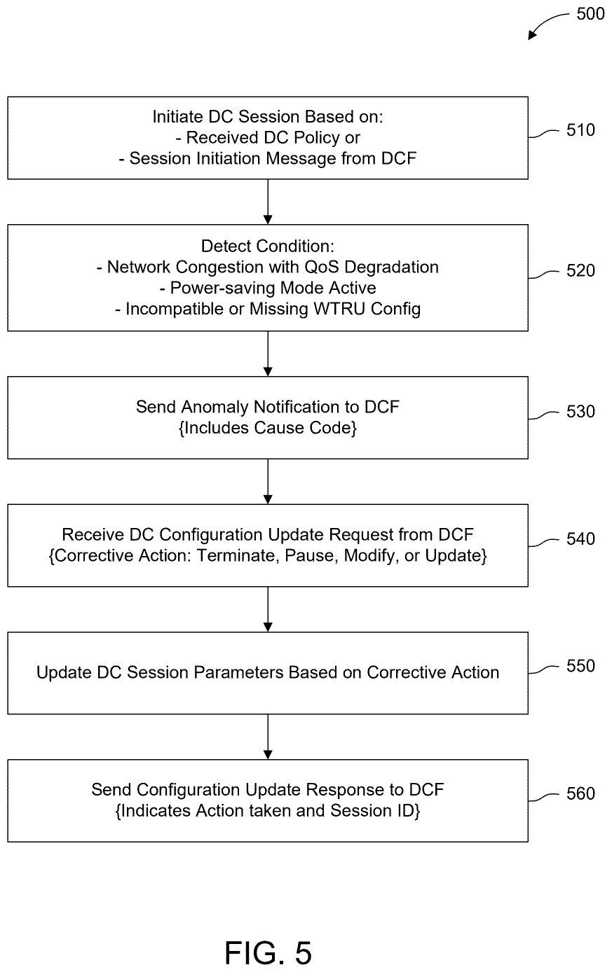

FIG. 5 illustrates a method 500 performed by a WTRU for participating in a data collection (DC) session. The process begins at 510, where the WTRU initiates the DC session based on either a received data collection policy or a session initiation message from a DCF. At 520, the WTRU detects that one or more operational conditions exist that may impair data collection, such as network congestion resulting in QoS degradation, activation of a power-saving mode, or incompatible or missing configuration information. At 530, the WTRU transmits an anomaly notification to the DCF, including a cause code that indicates the nature of the issue. At 540, the WTRU receives a configuration update request from the DCF that specifies a corrective action, such as termination, pause, modification, or update of the DC session. The WTRU implements the corrective action at 550 by updating the relevant session parameters, and at 560, it sends a response back to the DCF indicating the action taken and the associated DC session ID.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of managing a data collection (DC) session performed by a network node configured to serve as a
data collection function (DCF), the method comprising:
monitoring one or more data collection session using an abnormality detection mechanism configured to detect whether data collection is proceeding in accordance with a data collection policy;
detecting a data collection abnormality based on: a notification that collected data fails to meet a data consuming application requirement, a notification that indicates a failure to meet a Quality of Service (QoS) or a Quality of Experience (QoE) requirement, or a notification from a network function (NF) including a forecast or detection of network congestion;
determining a corrective action based on a corresponding DC management rule and the detected data collection abnormality;
transmitting, to one or more wireless transmit receive units (WTRU)s, a data collection configuration request message based on the corrective action;
receiving, from the one or more WTRUs, a data collection configuration response message indicating an outcome of the corrective action, the outcome comprising at least one of: termination, pause, modification, rejection or update of the DC session; and
transmitting, to an application function (AF), a message indicating the corrective action outcome based on the data collection configuration response message.

2. The method of claim 1 further comprising detecting a data collection abnormality based on whether a data reporting schedule has been violated based on DC policy rules received from the AF.

3. The method of claim 1, wherein the notification that collected data fails to meet a data consuming application requirement is received from the AF and comprises a cause code indicating that data is either not required, or that the DC session requires a restart.

4. The method of claim 1, wherein the notification that indicates a failure to meet the QoS or QoE requirement is received from the one or more WTRUs comprises an indication of at least one of: network congestion, WTRU in power-saving mode, or incompatible configuration.

5. The method of claim 1, wherein the DCF is configured to subscribe to a Network Data Analytics Function (NWDAF) and receive notifications when network conditions indicate potential congestion or adverse conditions affecting one or more WTRUs.

6. The method of claim 1, wherein any of the notification that collected data fails to meet a data consuming application requirement, the notification that indicates a failure to meet a QoS or QoE requirement, or the notification from the NF comprises at least one of a data collection policy identifier, impacted geographical location, list of impacted base stations (gNBs), or one or more QoS parameters not being met.

7. The method of claim 1, wherein the data consuming application requirement is an artificial intelligence or machine learning (AIML) model training requirement, or a requirement for maintaining a spatial map.

8. The method of claim 1, wherein the corrective action comprises updating the data reporting frequency, buffer thresholds, or retry behavior associated with the DC session.

9. A network node configured to serve as a data collection function (DCF) for managing a data collection (DC) session, the networking node comprising:
a processor; and
a transceiver, wherein the processor and transceiver are configured to:
monitor one or more data collection session using an abnormality detection mechanism configured to detect whether data collection is proceeding in accordance with a data collection policy;
detect a data collection abnormality based on: a notification that collected data fails to meet a data consuming application requirement, a notification that indicates a failure to meet a Quality of Service (QoS) or a Quality of Experience (QoE) requirement, or a notification from a network function (NF) including a forecast or detection of network congestion;
determine a corrective action based on a corresponding DC management rule and the detected data collection abnormality;
transmit, to one or more wireless transmit receive units (WTRU)s, a data collection configuration request message based on the determined corrective action;
receive from the one or more WTRUs, a data collection configuration response message indicating an outcome of the corrective action, the outcome comprising at least one of: termination, pause, modification, rejection or update of the DC session; and
transmit to an application function (AF), a message indicating the outcome of the corrective action based on the data collection configuration response message received from the one or more WTRUs.

10. The network node of claim 9, wherein the processor and transceiver are further configured to: detect a data collection abnormality based on whether a data reporting schedule has been violated based on DC policy rules received from the AF.

11. The network node of claim 9, wherein the notification that collected data fails to meet a data consuming application requirement is received from the AF and comprises a cause code indicating that data is either not required, or that the DC session requires a restart.

12. The network node of claim 9, wherein the notification that indicates a failure to meet the QoS or QoE requirement is received from the one or more WTRUs comprises an indication of at least one of: network congestion, WTRU in power-saving mode, or incompatible configuration.

13. The network node of claim 9, wherein the DCF is configured to subscribe to a Network Data Analytics Function (NWDAF) and receive notifications when network conditions indicate potential congestion or adverse conditions affecting one or more WTRUs.

14. The network node of claim 9, wherein any of the notification that collected data fails to meet a data consuming application requirement, the notification that indicates a failure to meet a QoS or QoE requirement, or the notification from the NF comprises at least one of a data collection policy identifier, impacted geographical location, list of impacted base stations (gNBs), or one or more QoS parameters not being met.

15. The network node of claim 9, wherein the data consuming application requirement is an artificial intelligence or machine learning (AIML) model training requirement, or a requirement for maintaining a spatial map.

16. The network node of claim 9, wherein the corrective action comprises updating a data reporting frequency, buffer thresholds, or retry behavior associated with the DC session.

17. A method performed by a wireless transmit receive unit (WTRU) participating in a data collection (DC) session, the method comprising:
initiating a DC session based on at least one of: a received data collection policy or a session initiation message from a data collection function (DCF);
detecting that one or more conditions exist, including at least one of: network congestion with Quality of Service (QoS) degradation, activation of a power-saving mode, or incompatible or missing WTRU configuration information;
transmitting, to the DCF, an anomaly notification comprising a cause code associated with the detected one or more conditions;
receiving, from the DCF, a data collection configuration update request indicating a corrective action, the corrective action comprising at least one of: termination, pause, modification, or update of the DC session;
updating one or more data collection session parameters based on the corrective action; and
transmitting, to the DCF, a data collection configuration update response, the response indicating the corrective action taken and identifying an associated DC session ID.

18. The method of claim 17, wherein the data collection session parameters include at least one of a data sampling rate, a data buffering threshold, or a reporting schedule.

19. The method of claim 17, wherein the anomaly notification comprises a WTRU identifier, current network condition, and an impacted QoS metric.

20. The method of claim 17, wherein the corrective action is based on a data collection management rule associated with a DC profile ID.
